(19) United States
(12) Patent Application Publication
(10) Pub. No.: US 2017/0326581 A1
(43) Pub. Date: Nov. 16, 2017

(54) PAINT ROLLER AND PAINT ROLLER ASSEMBLY INCLUDING A PAINT ROLLER AND A PAINT ROLLER SLEEVE

(71) Applicant: Rogiros Pavlou Georgiou, Lemesos (CY)

(72) Inventor: Rogiros Pavlou Georgiou, Lemesos (CY)

(21) Appl. No.: 15/155,612

(22) Filed: May 16, 2016

(51) Int. Cl. B05C 17/02

(52) U.S. Cl. CPC B05C 17/0207

(57) ABSTRACT

A paint roller, a collar for a paint roller sleeve, a paint roller kit, and a paint roller assembly are described. In accordance with one aspect of the present disclosure, there is provided a paint roller assembly, comprising a paint roller sleeve and a paint roller. The paint roller sleeve includes a tubular body defining a passage therethrough. The passage defines a first aperture at a first end of the tubular body and a second aperture at a second end of the tubular body. A first collar is received in the first aperture, and a second collar is received in the second aperture. The paint roller includes a spindle rod including a first end and a second end opposite to the first end. The paint roller also includes a first reel rotatably mounted on the spindle rod proximate to the first end of the spindle rod, and a second reel rotatably mounted on the spindle rod proximate to the second end of the spindle rod. The first reel includes an engagement portion at a first end thereof for releasably engaging the first collar.

### TECHNICAL FIELD

The present disclosure relates to paint rollers, and in particular, to a paint roller and a paint roller assembly including a paint roller and a paint roller sleeve.

### BACKGROUND

Paint rollers are well known devices for painting various surfaces such as walls and ceilings. There are two main types of paint rollers. The first type of paint roller uses a cage frame system that includes a cage frame form of a number of bent steel wires. The cage frame is fixed to one end of a spindle rod (or arm). A handle is attached to the other end of the spindle rod. An open tube paint roller sleeve (also known as a paint roller cover) is fit over the cage frame during use. The paint roller sleeve is held in place on the cage frame by a friction fit.

The open tube paint roller sleeves have a hollow tube body to which fabric is bonded. This type of paint roller sleeve presents some problems. One problem with open tube sleeves is corner rolling. Because fabric is bonded to a hollow tube body, the end of the paint roller sleeve can touch the wall when rolling corners. This can affect the painted area, damage the wall, and can cause the fabric to peel off, sometimes in as little as one day of heaving painting. Even if the fabric is attached to the ends of the paint roller sleeve, the fabric can start to wear and peel from the tube body with relatively little use. This limits the ability to re-use the paint roller sleeve.

Another problem with open tube sleeves is uneven rolling. The cage frame comprises a cage of bent steel wires, forming a cage, with plastic end reels located at the ends of the cage. The paint roller sleeve is fit on the cage frame and held in place by means of an outwardly biasing force of the steel wires pressing against the inside of the paint roller sleeve. For a variety of reasons, such as the lack of uniformity in the outwardly biasing force of the steel wires pressing against the inside of the paint roller sleeve, the pressure applied against the paint roller sleeve may be uneven, causing uneven paint application even when the user applies an even pressure during rolling.

A further problem with open tube sleeves is sleeve sliding. Because the paint roller sleeve is secured by the outwardly biasing force of the steel wires pressing against the inside of the paint roller sleeve, the paint roller sleeve can slide back and forth across the cage frame, causing uneven paint application and potentially interfering with previously painted surfaces.

The second type of paint roller uses a rod-frame system and was developed to solve problems of the cage frame design. The rod-frame system uses end caps received in an open tube paint roller sleeve. The end caps define a hole for a spindle rod to pass through. The rod is fixed at one end, for example using a turn screw or similar fitting, thereby clamping the paint roller sleeve to the roller. The second type, while addressing some of the problems of the cage frame design, is in many ways more complex and results in a more costly paint roller because of the increased use of materials and the increased time to assemble the paint roller.

Furthermore, during use paint may enter the interior of a paint roller having a rod-frame system through the holes in the end caps of the paint roller or possibly other assembly point, such as where the end caps meet the paint roller sleeve. When this occurs, the paint roller sleeve should be cleaned or discarded since the paint roller sleeve should be clean to prevent incidental off spray and dripping, etc. Accordingly, users cannot dip the paint roller in paint or leave the paint roller in paint for very long.

Further still, paint rollers with sleeves attached may be immersed in liquid, such as water, between uses to extend the useful life of the paint roller sleeve, possibly by several days. In addition, cleaning of the paint roller sleeve may be required, for example, after a period of non-use or after paint has leaked into the internals of the paint roller. The paint roller sleeve may be cleaned using water or a suitable chemical cleaning solvent (e.g., paint thinner or Varsol™) depending on the type of paint. It will be appreciated that the disposal of used chemical cleaning solvent is performed in accordance with local waste disposal and environmental regulations. The liquid used to clean or preserve the paint roller sleeve may enter the interior of the paint roller, for example if immersed for an extended duration. When this occurs, the paint roller should be disassembled and cleaned to prevent incidental off spray and dripping, etc. during subsequent use of the paint roller.

For the foregoing reasons and other reasons, there is a need for an improved paint roller.

### SUMMARY

The present disclosure provides embodiments of a paint roller, a paint roller sleeve, and a paint roller assembly comprising the paint roller and paint roller sleeve which seek to mitigate one or more deficiencies of existing paint rollers. Embodiments of the paint roller assembly are believed to extend the useful life of paint roller sleeves by reducing wear during use, allowing paint roller sleeves to be used several times.

Embodiments of the paint roller assembly are also believed to provide one or more of the following benefits: reduce interference with previously painted surfaces, reduce the likelihood of damage to the painting surface, reduced incidental spray and dripping, and/or provide a more even paint application. For example, compared with conventional paint rollers using the cage frame system or rod-frame system, embodiments of the paint roller assembly of the present disclosure exhibit little or no sliding of the paint roller sleeve, thereby improving the quality of the painted surface. In addition, compared with conventional paint rollers using the rod-frame system, embodiments of the paint roller assembly of the present disclosure reduce or eliminate the likelihood that paint or cleaning solvents may enter the internals of the paint roller, thereby reducing or eliminating the need to clean the paint roller and/or paint roller sleeve.

Embodiments of the paint roller assembly are also believed to releasably secure paint roller sleeves to the paint roller in a more secure manner while also permitting paint roller sleeves to be installed and removed by users with relative ease. For example, compared with paint rollers using the cage frame system or rod-frame system, embodiments of the paint roller assembly of the present disclosure exhibit little or no sliding of the paint roller sleeve, thereby reducing or eliminating lost time required to reinstall the paint roller sleeve.

Embodiments of the paint roller assembly are also believed to be lighter and have a relatively simple construction, providing a paint roller which is easier and more cost effective to manufacture due to reduced manufacturing times and reduced raw materials (e.g., steel and plastic).

In accordance with a first aspect of the present disclosure, there is provided a paint roller. The paint roller includes a spindle rod including a first end and a second end opposite to the first end. The paint roller also includes a first reel rotatably mounted on the spindle rod proximate to the first end of the spindle rod, and a second reel rotatably mounted on the spindle rod proximate to the second end of the spindle rod. The first reel includes an engagement portion at a first end thereof for releasably engaging the first collar.

In accordance with a second aspect of the present disclosure, there is provided a collar for a paint roller sleeve, comprising: a tubular body defining a passage therethrough, wherein the collar includes an engagement portion for engagement by a reel of a paint roller. The collar is configured (including being sized) to be received in an aperture defined by a paint roller sleeve.

In some embodiments, the engagement portion is located at one end thereof. In some embodiments, the engagement portion is one of an annular projection or an annular groove for engagement by an engagement portion of the reel, which is the other of the annular projection or the annular groove.

In some embodiments, the passage through the tubular body is cylindrical. In other embodiments, the passage through the tubular body is conical. In some embodiments, the collar has a flange at one end thereof, and the conical passage has an inner diameter which narrows in the direction extending away from the flange.

In some embodiments, the collar has a flange at one end thereof, and the flange is configured (including being sized) so as to extend above a fabric layer of the paint roller sleeve.

In accordance with a third aspect of the present disclosure, there is provided a paint roller sleeve. The paint roller sleeve includes a tubular body defining a passage therethrough. The passage defines a first aperture at a first end of the tubular body and a second aperture at a second end of the tubular body. The paint roller sleeve also includes a fabric layer attached to the tubular body, a first collar received in the first aperture of the tubular body, and a second collar received in the second aperture of the tubular body.

In accordance with a fourth aspect of the present disclosure, there is provided a paint roller assembly, comprising a paint roller sleeve and a paint roller. The paint roller sleeve includes a tubular body defining a passage therethrough. The passage defines a first aperture at a first end of the tubular body and a second aperture at a second end of the tubular body. A first collar is received in the first aperture, and a second collar is received in the second aperture. The paint roller includes a spindle rod including a first end and a second end opposite to the first end. The paint roller also includes a first reel rotatably mounted on the spindle rod proximate to the first end of the spindle rod, and a second reel rotatably mounted on the spindle rod proximate to the second end of the spindle rod. The first reel includes an engagement portion at a first end thereof for releasably engaging the first collar.

In some embodiments, the paint roller sleeve is received on the paint roller, wherein the engagement portion of the first reel releasably engages the first collar of the paint roller sleeve received in the first aperture.

In some embodiments, the first reel, second reel, first collar and second collar each comprise a tubular body defining a passage therethrough, wherein the tubular bodies of the first reel and second reel each have an outer diameter which is smaller than an inner diameter of the tubular bodies of the first collar and second collar, respectively.

In some embodiments, the first collar and second collar each comprise a tubular body defining a conical passage therethrough, wherein the conical passages have an inner diameter which narrows in the direction extending away from the respective ends of the paint roller sleeve.

In some embodiments, the engagement portion of the first reel comprises a plurality of evenly spaced apart cantilever-type snap fittings arranged circumferentially therearound. In some embodiments, the first collar comprises a tubular body defining a conical passage therethrough, and wherein the cantilever-type snap fittings engage one end of the tubular body of the first collar. In some embodiments, the cantilever-type snap fittings comprise a projection which defines an angled assembly surface and an angled disassembly surface which allow the paint roller sleeve to be installed and removed.

In some embodiments, the first collar includes an engagement portion at a first end thereof, wherein the engagement portion of the first reel is one of an annular projection or an annular groove, and the engagement portion of the first collar is the other of the annular projection or the annular groove. In some embodiments, the first reel includes a plurality of evenly spaced apart slots extending longitudinally inward from a first end of the first reel.

In some embodiments, the first collar and second collar each have a flange at one end thereof, wherein the flange of the first collar abuts the flange of the first reel when the paint roller sleeve is received on the paint roller.

In some embodiments, the first collar and second collar each have a flange at one end thereof, wherein the flanges of the first collar and second collar extend above a fabric layer of the paint roller sleeve.

In some embodiments, the second end of the spindle rod connects to a bent arm. In some embodiments, the paint roller assembly further comprises a handle connected to the bent arm.

In accordance with a fifth aspect of the present disclosure, there is provided a kit, comprising: a first collar to be received within a first aperture of a passageway defined by a paint roller sleeve; a second collar to be received within a second aperture of the passageway defined by the paint roller sleeve located opposite to the first aperture; and a paint roller as described herein. In some embodiments, the kit includes instructions for assembling a paint roller assembly including the paint roller, paint roller sleeve, and first and second collars and/or using the paint roller assembly. In some embodiments, the instructions specify that assembling comprises inserting the first and second collars into apertures defined by the paint roller sleeve, and inserting the paint roller sleeve, with the first and second collars received in the first and second apertures, onto the paint roller.

Other aspects and features of the present disclosure will be apparent to those skilled in the art including regard to the following drawings and detailed description.

### BRIEF DESCRIPTION OF THE DRAWINGS

Reference will now be made, by way of example, to the accompanying drawings which show example embodiments of the present disclosure, and in which:

FIG. 1 is a perspective view of a paint roller assembly including a paint roller and paint roller sleeve in accordance with a first embodiment of the present disclosure.

FIG. 2 is a sectional view of the paint roller assembly of FIG. 1 taken along line 2-2.

FIG. 3 is a side view of the paint roller of FIG. 1.

FIG. 4 is a sectional view of a paint roller sleeve of FIG. 1.

FIG. 5 is a sectional view of a reel attached to a spindle rod of the paint roller of FIG. 1.

FIG. 6 is a sectional view of a collar inserted into the paint roller sleeve of FIG. 1.

FIG. 7 is a perspective view of the reel shown in FIG. 5.

FIG. 8 is a perspective view of the reel shown in FIG. 5 with the collar of FIG. 6 received thereon.

FIG. 9 is an end view of FIG. 2 taken along line 9-9.

FIG. 10A is partial side view of a paint roller in accordance with a second embodiment of a paint roller assembly of the present disclosure showing detail of the first reel.

FIG. 10B is a sectional view of the first reel in accordance with the paint roller of the second embodiment.

FIG. 10C is partial perspective view of the paint roller of the second embodiment showing detail of the first reel.

FIG. 11 is a sectional view of a collar for a paint roller sleeve in accordance with the second embodiment.

FIG. 12 is a sectional view of the paint roller assembly in accordance with the second embodiment.

FIG. 13 is a partial, enlarged view of the paint roller assembly of FIG. 12 showing detail of the first reel.

### DETAILED DESCRIPTION OF EXAMPLE EMBODIMENTS

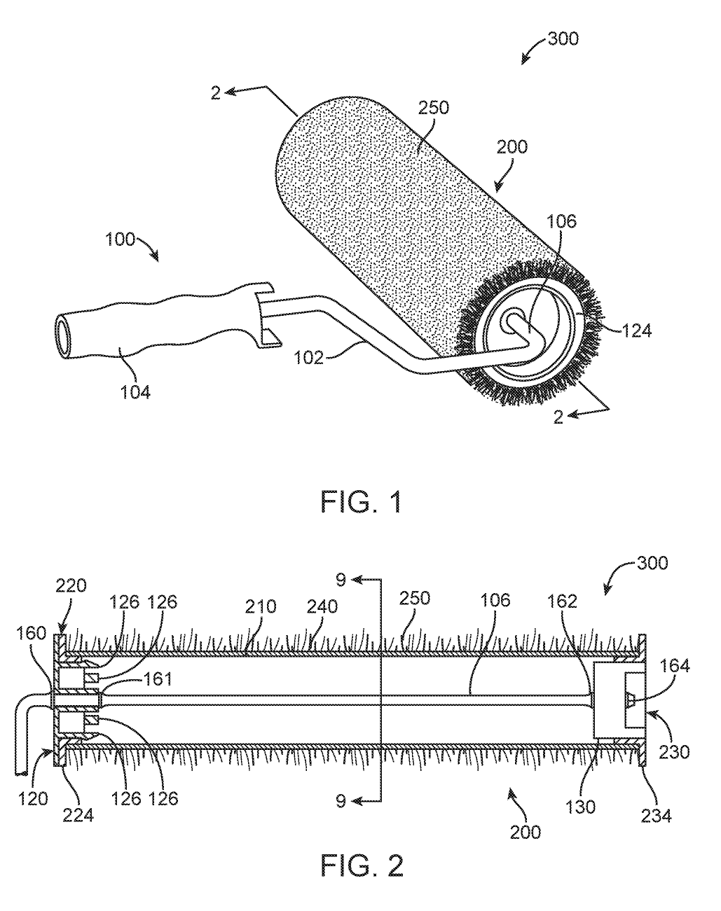

FIGS. 1 and 2 illustrate a paint roller assembly 300 in accordance with a first embodiment of the present disclosure. The paint roller assembly 300 includes a paint roller 100 and paint roller sleeve (or cover) 200 removably inserted or received upon the paint roller 100. The paint roller 100 includes a multi-angled (“bent”) arm 102 including a spindle rod 106 at one end and a handle 104 at the other end. The spindle rod 106 has a first end and a second end located opposite to the first end.

The arm 102 is metal, e.g. steel, but other materials could be used in other embodiments. The handle 104 may be fixed to the arm 102 or may be removable, for example, using a threaded connection to the end of the arm 102. The handle 104 may be shaped or profiled for a better grip or comfort of the user. The handle 104 may be made from plastic, wood or other suitable material.

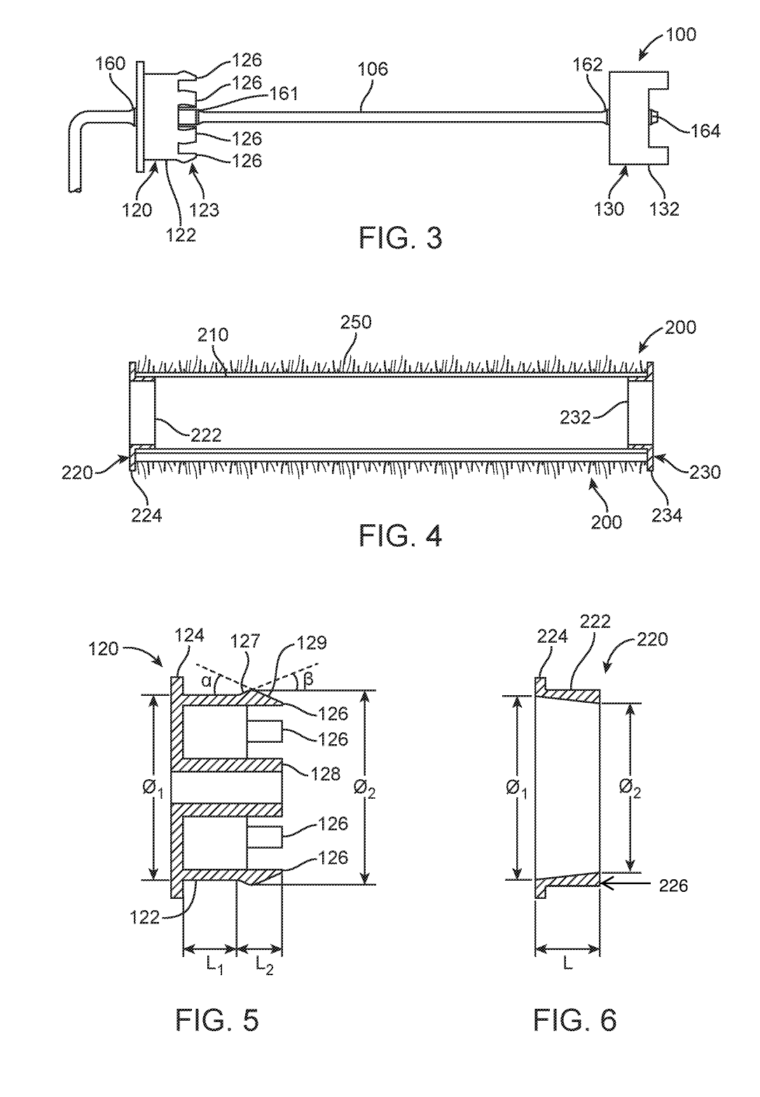

The paint roller sleeve 200 may be a conventional open tube paint roller sleeve. As best shown in FIG. 3, the paint roller sleeve 200 comprises a tubular body 210 defining a cylindrical passage therethrough and a fibre layer 250 attached to the tubular body 210. The fibre layer 250 may be attached to the tubular body 210 using any suitable technique, such as gluing, thermal bonding, etc. The fibre layer 250 may be made of polyester, microfiber, or other suitable fibrous material. The fibre layer 250 extends around the outer surface of the tubular body 210 and is used to receive and retain paint during use. In other embodiments, a cushion layer may be provided between the tubular body 210 and the fibre layer 250. In such embodiments, the cushion layer is attached to the tubular body 210 and the fibre layer 250 is attached to the cushion layer.

The length and/or diameter of the paint roller sleeve 200 are sized to fit the paint roller 100. The size and dimensions of the paint roller 100 and paint roller sleeve 200, while preferably adapted to accept a conventional open tube paint roller sleeve, may vary between embodiments.

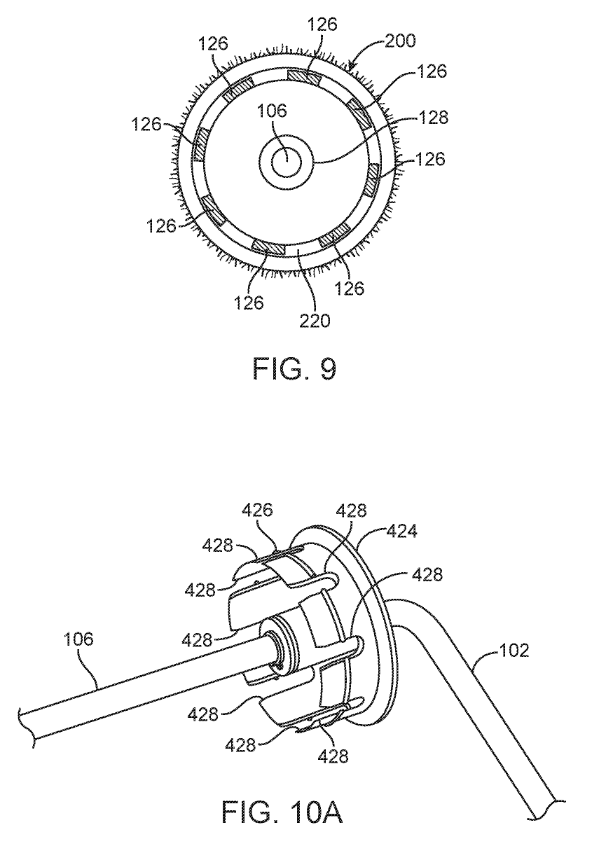

Referring now to FIGS. 3 to 9, the paint roller 100 of the first embodiment will be described in more detail. The cylindrical passage of the tubular body 210 defines a first aperture at a first end of the tubular body 210 and a second aperture at a second end of the tubular body 210. A first collar 220 is received in the first aperture of the tubular body 210. A second collar 230 is received in the second aperture of the tubular body 210. The first collar 220 and second collar 230 are the same in the first embodiment. In other embodiments, the first collar 220 and second collar 230 may be different.

The collars 220, 230 each have a tubular body, represented respectively by reference numerals 222, 232, which define a conical passage therethrough. The conical passages have an inner diameter which narrows in the direction extending away from the respective ends of the paint roller sleeve. A flange (or lip), represented respectively by reference numerals 224, 234, is located at a first end of the collars 220, 230. The conical passage of the collars 220, 230 defines a first aperture at a first end and a second aperture at a second end. When the collars 220,230 are installed in the paint roller sleeve 200, the flanges 224, 234 extend above the fabric layer 250 of the paint roller sleeve 200. This prevents the paint roller sleeve 200 from touching a wall during use, for example, when corning roller. In one example, the flanges 224, 234 are configured (e.g., sized) to extend approximately 2 mm above the outer surface of the fabric layer 250 of the paint roller sleeve 200. The size of the flanges 224, 234 may vary in other embodiments.

As best shown in FIG. 6, which illustrates the first collar 220 in detail, the inside surface of the collars 220, 230 is conical, narrowing in the direction extending away from the flange 224, 234. The diameter of the first aperture, i.e. the inside diameter of the tubular body 222 at the first end, is denoted Ø₁. The diameter of the second aperture, i.e. the inside diameter of the tubular body 222 at the second end, is denoted Ø₂. The diameter Ø₂ at the second end is smaller than the diameter Ø₁ at the first end, as a result of the conical shape of the inside surface of the collar 220. In one example, the diameter Ø₂ at the second end is approximately 40.2 mm whereas the diameter Ø₁ at the first end is approximately 40.5 mm. Other sizes could be used in other embodiments.

The first collar 220 and second collar 230 are permanently fixed, or integrated with, the body of tubular body 210 of the paint roller sleeve 200 so that the first collar 220 and second collar 230 do not readily release during use. In some examples, the tubular body 210 of the paint roller sleeve 200 and the collars 220, 230 are made from polypropylene and bonded together using ultrasonic bonding. In other embodiments, a suitable adhesive or other suitable means may be used to fix the collars 220, 230 to the paint roller sleeve 200. In yet other embodiments, the tubular body 210 of the paint roller sleeve 200 and the collars 220, 230 may be extruded as a single, integrated part.

Referring to FIG. 3, a first reel 120 is rotatably mounted on the spindle rod 106 proximate to the first end of the spindle rod 106. A second reel 130 is rotatably mounted on the spindle rod 106 proximate to the second end of the spindle rod 106. The distance between the reels 120, 130 and the diameter of the hub of the first and second reels 120, 130 is configured (e.g., sized) to accommodate the paint roller sleeve 200. Fasteners 160, 161, 162, 164 located at opposite ends of the reels 120, 130 the restrict lateral movement of the reels 120, 130 along the length spindle rod 106 so that there is little or no lateral movement while allowing the reels 120, 130 to rotate freely about the spindle rod 106. Suitable fasteners and fastening means will be understood to the skilled person and will not be described herein. Any suitable type of fasteners 160, 161, 162, 164 or fastening means which provide the desired range of movement can be used.

The first reel 120 and second reel 130 each comprise a tubular body, represented respectively by reference numerals 122, 132. The tubular bodies 122, 132 each include a hub comprising a cylindrical body that defines a cylindrical passage therethrough for receiving the spindle rod 106. As best shown in FIG. 5, the first reel 120 includes an engagement portion at a first end thereof for releasably engaging the first collar 220 as will be described in more detail below. The first reel 120 also includes a flange 124 at a second end thereof.

The tubular bodies 122, 132 of the first reel 120 and second reel 130, have an outer diameter which is smaller than an inner diameter of the conical passages through the tubular bodies 222, 232 of the first collar 220 and second collar 230, respectively. The outer and inner diameters are relatively similar and are selected so that the paint roller sleeve 200 fits snugly on the reels 120, 130 of the paint roller 100 when the paint roller sleeve 200 is installed.

The engagement portion of the first reel 120 comprises a number of evenly spaced cantilever-type snap fittings 126 arranged circumferentially about the tubular body 122. In one example, the outer diameter of the tubular body 112 of the first reel 120 is approximately 40.5 mm, and there are 8 cantilever-type snap fittings 126 evenly spaced circumferentially around the tubular body 122. The cantilever-type snap fittings have width of approximately 8 mm and are spaced apart by approximately 8 mm. A different size, number and/or distance between the cantilever-type snap fittings 126 may be used in other embodiments. In some examples, a spacing between the cantilever-type snap fittings of between approximately 4 mm and approximately 12 mm has been found to be effective. The size (e.g., width) of the cantilever-type snap fittings 126 may change depending on the number and/or spacing of the cantilever-type snap fittings 126.

Each of the cantilever-type snap fittings 126 comprise a small projection (or protrusion) including a pair of surfaces 127, 129 angled relative to the tubular body 122. The surface 129 provides an angled assembly surface. The surface 127 provides an angled disassembly surface. The projections catch the end of the first collar 220 when the paint roller sleeve 200 is installed. The size and position of the cantilever-type snap fittings 126 and the first collar 220 are selected so that the cantilever-type snap fittings 126 catches the end of the first collar 220 when the first collar 220 is fully seated on the first reel 120 and the paint roller sleeve 300 is fully inserted.

The projection of the cantilever-type snap fittings 126 is a triangular projection, and in particular, an asymmetric triangular projection in the shape of an oblique or scalene triangle. The surface 127 of the triangular projection defines a first base angle, a, relative to the tubular body 122, and the surface 129 of the triangular projection defines a second base angle, β, relative to the tubular body 122. The first base angle (α) is larger than the second base angle (β). In one example, the length of the cantilever-type snap fittings 126, denoted L₂, is approximately 8.0 mm, with a horizontal distance of approximately 3.0 mm between the end of the tubular body 122 to an apex of the cantilever-type snap fittings 126 and a horizontal distance of approximately 5.0 mm between the apex of the cantilever-type snap fittings 126 and the tip thereof. Cantilever-type snap fittings having a different size or shape may be used in other embodiments.

Referring again to FIGS. 5 and 6, dimensions of one example of the paint roller assembly 100 will be described. The tubular body 122 of the first reel 120, denoted L₁, is approximately 15.0 mm and the length of the first collar 220, denoted L, is approximately 15.0 mm. This sizing allows the first collar 220 to be fully seated on the tubular body 122 of the first reel 120. The outside diameter of the tubular body 122, denoted Ø₁, is approximately 40.0 mm and the outside diameter of the cantilever-type snap fittings 126 measured from the apex is approximately 40.5 mm. The first collar 220 has a conically shaped interior surface which narrows (tapers) in the direction extending away from the flange 224 so that the inside diameter of the tubular body 222, denoted Ø₁, at the first, flanged end is approximately 40.5 mm whereas the inside diameter of the tubular body 222, denoted Ø₂, at the second, opposite end is approximately 40.2 mm. This sizing provides a tolerance of 0.2 mm between the outside diameter of the first reel 120 and the inside diameter of the first collar 220.

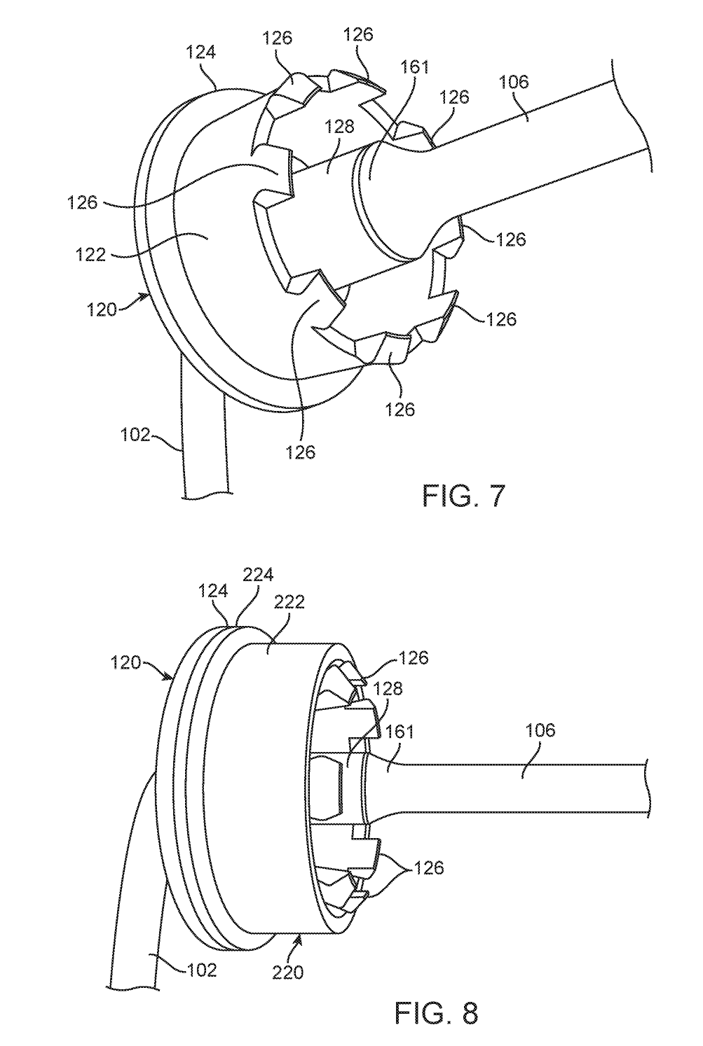

The paint roller sleeve 200 is releasably secured on the paint roller 100 during use to provide a paint roller assembly 300. The engagement portion of the first reel 120 releasably engages the first collar 220 of the paint roller sleeve 200 so that the paint roller sleeve 200 can be easily installed or removed from the paint roller 100. The engagement portion of the first reel 120 releasably engages a corresponding engagement portion of the first collar 120, which in the present embodiment, is the second end of the tubular body 222 of the first collar 220 without the flange 224, for example, at an outer edge 226 thereof, During the installation of the paint roller sleeve 200, the outer surface 129 of the snap fittings 126 engage the outer edge of the first collar 220 in response to the application of force along the spindle axis in the direction of the first reel 120, causing the snap fittings 126 to be deflected and displaced downwardly and inwardly. This allows the first collar 220 of the paint roller sleeve 200 to be pushed over the snap fittings 126 and releasably secured on the first reel 120. FIGS. 7 and 8 illustrate the first reel 120 with and without the first collar 220 received thereon, respectively. It will be appreciated that, in practice, the first collar 220 will only be received on the first reel 120 when previously installed in the paint roller sleeve 200. As shown best in FIG. 8, when the first collar 220 is received on the first reel 120, the flange 224 abuts the flange 124 of the first reel 120.

During removal of the paint roller sleeve 200, the inner surface 127 of the snap fittings 126 engage the inner edge of the first collar in response to the application of force along the spindle axis in the direction of the second reel 130 (opposite to the first reel 120), causing the snap fittings 126 to be deflected and displaced downwardly and inwardly. This allows the paint roller sleeve 200 to be pulled over the snap fittings 126 and removed from the paint roller 100 with relative ease, without the application of undue force and without a squeezing action.

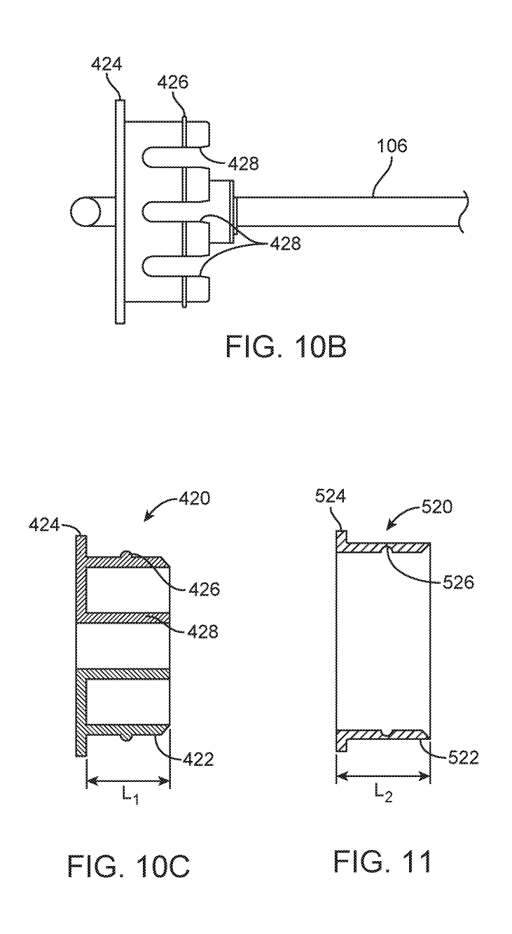

FIGS. 10A to 13 illustrate a paint roller assembly 600 in accordance with a second embodiment of the present disclosure. The second embodiment is similar to the first embodiment in many respects but differs from the first embodiment in the construction of the reels and collars.

The paint roller assembly 600 includes a paint roller 400 and paint roller sleeve 500 removably inserted or received upon the paint roller 400. The paint roller sleeve 500 is similar to the paint roller sleeve 200 described above but differs in the construction of the collars received therein. A first collar 520 is received in the first aperture of the tubular body 210. A second collar 530 is received in the second aperture of the tubular body 210. The first collar 520 and second collar 530 are the same in the second embodiment. In other embodiments, the first collar 520 and second collar 530 may be different. The first collar 520 and second collar 530 are permanently fixed, or integrated with, the body of tubular body 210 of the paint roller sleeve 200 so that the first collar 220 and second collar 230 do not readily release during use.

The collars 520, 530 each have a tubular body, represented respectively by reference numerals 522, 532, which define a cylindrical passage therethrough. A flange, represented respectively by reference numerals 524, 534, is located at a first end of the collars 520, 530. The cylindrical passage of the collars 520, 530 defines a first aperture at a first end and a second aperture at a second end. In some examples, when the collars 520,530 are installed in the paint roller sleeve 200, the flanges 524, 534 extend above the fabric layer 250 of the paint roller sleeve 200. This prevents the paint roller sleeve 200 from touching a wall during use, for example, when corning roller. In one example, the flanges 524, 534 extend approximately 2 mm above the outer surface of the fabric layer 250 of the paint roller sleeve 200. The size of the flanges 524, 534 may vary in other embodiments.

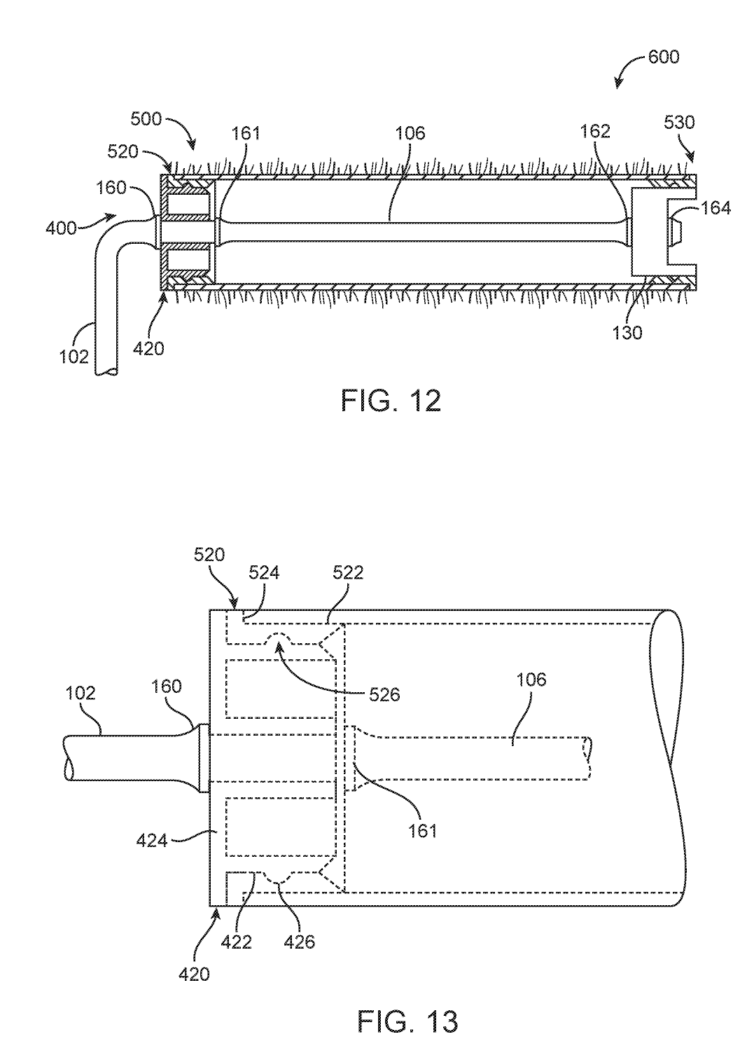

Referring to FIG. 12, a first reel 420 is rotatably mounted on the spindle rod 106 proximate to the first end of the spindle rod 106. A second reel 130 is rotatably mounted on the spindle rod 106 proximate to the second end of the spindle rod 106. The second reel 130 is the same as that described above. The distance between the reels 420, 130 and the diameter of the hub of the first and second reels 420, 130 is configured (e.g., sized) to accommodate the paint roller sleeve 200. Fasteners 160, 161, 162, 164 located at opposite ends of the reels 120, 130 the restrict lateral movement of the reels 120, 130 along the length spindle rod 106 so that there is little or no lateral movement while allowing the reels 120, 130 to rotate freely about the spindle rod 106.

The tubular bodies 422, 432 of the first reel 420 and second reel 130, have an outer diameter which is slightly smaller than the inner diameter of the cylindrical passages through the tubular bodies 522, 532 of the first collar 520 and second collar 530, respectively. The outer and inner diameters are relatively similar and are selected so that the paint roller sleeve 500 fits snugly on the reels 420, 130 of the paint roller 400 when the paint roller sleeve 500 is installed.

As best shown in FIGS. 10A to 10C, the first reel 420 comprises a tubular body 422. The tubular body includes a hub comprising a cylindrical body that defines a cylindrical passage therethrough for receiving the spindle rod 106. The first reel 420 has a longitudinal axis in line with the axis of the spindle rod 106. The first reel 420 includes an engagement portion at a first end thereof for releasably engaging the first collar 520, in particular, the engagement portion of the first reel 420 releasably engages a corresponding engagement portion of the first collar 520, as will be described in more detail below. The first reel 420 also includes a flange 424 at a second end thereof.

The engagement portion comprises an annular projection (or ring, protrusion, ridge) 426 extending from the tubular body 422. In some examples, the annular projection 426 is rounded. In other examples, the annular projection 426 is triangular as in the illustrated embodiment. The first collar 520 and second collar 520 each include an engagement portion for engaging the first reel 420. The engagement portion comprises an annular groove (or recess) 526 defined on the inner surface of the first collar 520 for engaging or catching by the annular projection 426 on the outside of the first reel 420. The size and position of the annual groove 526 and annular projection 426 are selected so that the protrusion 426 catches the groove when the first collar 520 is fully seated on the first reel 420 and the paint roller sleeve 500 is fully inserted. The height of the annular projection 426 and the depth of the annual groove 526 are approximately 0.5 mm, respectively. Other sizes may be used in other embodiments. It will be appreciated that increasing the depth of the annual groove 526 decreases the strength of the collars 520, 530 for given material thickness. If the depth of the annual groove 526 is too large, the collars 520, 530 may not be sufficiently strong for regular use.

As best shown in FIGS. 10A and 10C, the first reel 420 also includes a number of spaced apart tabs separated by a number of spaced apart slots (or cuts) 428. In one example, the diameter of the tubular body 422 of the first reel 420 is approximately 40 mm and includes 8 equally spaced apart slots 428 extending longitudinally inward from the first end of the first reel 420 along the longitudinal axis of the first reel 420. In some examples, slots 428 having a width of approximately 4 mm and approximately 12 mm have been found to be effective. In one example, the tabs have a width of approximately 12 mm and are spaced apart by slots 428 approximately 5 mm wide and approximately 12 mm deep as measured from the first end of the tubular body 422. In other embodiments, a different number and/or spacing between the slots 428 may be used. For example, the number of slots 428 may vary between 6 and 12 depending on the width of the material between the slots 428. It will be appreciated that increasing the number and/or width of the slots 428 decreases the strength of the first reel 420 for given material thickness. If the number or width of the slots 428 is too large, the first reel 420 may not be sufficiently strong for regular use.

The paint roller sleeve 500 is releasably secured on the paint roller 400 during use to provide a paint roller assembly 600. The engagement portion of the first reel 420 releasably engages the first collar 520 of the paint roller sleeve 500 so that the paint roller sleeve 500 can be easily installed or removed from the paint roller 400. During the installation of the paint roller sleeve 500, the annual projection 426 on the first reel 420 engages the annual recess 526 of the first collar 520 in response to the application of force along the spindle axis in the direction of the first reel 420, causing the tubular body 422 to be deflected and displaced downwardly and inwardly. This allows the first collar 520 of the paint roller sleeve 500 to be pushed over the annual projection 426 and releasably secured on the first reel 420. As shown best in FIG. 13, when the paint roller sleeve 500 is installed, the first collar 520 fits over the tubular body 422 of the first reel 420 and the second collar 530 fits over the tubular body 132 of the second reel 130. In addition, when the first collar 520 is received on the first reel 420, the flange 524 abuts the flange 424 of the first reel 420.

During removal of the paint roller sleeve 500, the annual projection 426 engage the inner edge of the annual recess 526 in response to the application of force along the spindle axis in the direction of the second reel 130 (opposite to the first reel 120), causing the tubular body 422 to be deflected and displaced downwardly and inwardly. This allows the paint roller sleeve 500 to be pulled over the annual projection 426 and removed from the paint roller 400 with relative ease, without the application of undue force and without a squeezing action.

Variations to the paint roller assemblies described above are possible. For example, while in the shown embodiment of FIGS. 10A to 13, the engagement portion of the first reel 420 comprises an annular projection on the outside surface of the tubular body 422 and the engagement portion of the first collar 520 comprises an annular groove on the inside surface of the tubular body 522, the position of the annular projection and annular groove may be switched in other embodiments so that the annular groove is on the outside surface of the first reel 420 and the annular projection is on the inside surface of the first collar 520. The annular projection and annular groove of the second embodiment provide an annular snap fitting as an alternate style to the cantilever-type snap fittings of the first embodiment. In other embodiments, a different style of snap fitting may be incorporated into the reels and collars so that the paint roller assembly can be releasably secured to the paint roller.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the preferred embodiments set forth in the examples, but should be given the broadest interpretation consistent with the description as a whole.

1. A paint roller comprising:
a spindle rod including a first end and a second end opposite to the first end;
a first reel rotatably mounted on the spindle rod proximate to the first end of the spindle rod, the first reel comprising an engagement portion at a first end thereof a releasably engaging a paint roller sleeve; and
a second reel rotatably mounted on the spindle rod proximate to the second end of the spindle rod.

2. The paint roller of claim 1, wherein the engagement portion of the first reel comprises a plurality of evenly spaced apart cantilever-type snap fittings arranged circumferentially therearound.

3. The paint roller of claim 2, wherein the cantilever-type snap fittings comprise a projection which defines an angled assembly surface and an angled disassembly surface which allow the paint roller sleeve to be installed and removed.

4. The paint roller of claim 1, wherein the first collar includes an engagement portion at a first end thereof, wherein the engagement portion of the first reel is one of an annular projection or an annular groove, and the engagement portion of the first collar is the other of the annular projection or the annular groove.

5. The paint roller of claim 4, wherein the first reel includes a plurality of evenly spaced apart slots extending longitudinally inward from a first end of the first reel.

6. A kit, comprising:
a first collar to be received within a first aperture of a passageway defined by a paint roller sleeve;
a second collar to be received within a second aperture of the passageway defined by the paint roller sleeve located opposite to the first aperture;
a paint roller comprising:
a spindle rod including a first end and a second end opposite to the first end;
a first reel rotatably mounted on the spindle rod proximate to the first end of the spindle rod, the first reel including an engagement portion at a first end thereof for releasably engaging the first collar; and
a second reel rotatably mounted on the spindle rod proximate to the second end of the spindle rod.

7. The kit of claim 6, wherein the first reel, second reel, first collar and second collar each comprise a tubular body defining a passage therethrough, wherein the tubular bodies of the first reel and second reel each have an outer diameter which is smaller than an inner diameter of the tubular bodies of the first collar and second collar, respectively.

8. The kit of claim 6, wherein the first collar and second collar each comprise a tubular body defining a conical passage therethrough, wherein the conical passages have an inner diameter which is configured to, when the paint roller sleeve is received on the paint roller with the first collar and second collar received in the paint roller sleeve, narrow in the direction extending away from respective ends of the paint roller sleeve.

9. The kit of claim 6, wherein the engagement portion of the first reel comprises a plurality of evenly spaced apart cantilever-type snap fittings arranged circumferentially therearound.

10. The kit of claim 9, wherein the first collar comprises a tubular body defining a conical passage therethrough, and wherein the cantilever-type snap fittings engage one end of the tubular body of the first collar.

11. The kit of claim 9, wherein the cantilever-type snap fittings comprise a projection which defines an angled assembly surface and an angled disassembly surface which allow the paint roller sleeve to be installed and removed, respectively, when the first collar and second collar are received in the paint roller sleeve.

12. The kit of claim 6, wherein the first collar includes an engagement portion at a first end thereof, wherein the engagement portion of the first reel is one of an annular projection or an annular groove, and the engagement portion of the first collar is the other of the annular projection or the annular groove.

13. The kit of claim 12, wherein the first reel includes a plurality of evenly spaced apart slots extending longitudinally inward from a first end of the first reel.

14. The kit of claim 6, wherein the first collar and second collar each have a flange at one end thereof, wherein the flange of the first collar is configured to abut the flange of the first reel when the paint roller sleeve is received on the paint roller with the first collar and second collar received in the paint roller sleeve.

15. The kit of claim 6, wherein the first collar and second collar each have a flange at one end thereof, wherein the flanges of the first collar and second collar are configured to extend above a fabric layer of the paint roller sleeve when the paint roller sleeve is received on the paint roller with the first collar and second collar received in the paint roller sleeve.

16. A paint roller assembly comprising:
a paint roller sleeve comprising:
a tubular body defining a passage therethrough, the passage defining a first aperture at a first end of the tubular body and a second aperture at a second end of the tubular body;
a fabric layer attached to the tubular body;
a first collar received in the first aperture of the tubular body; and
a second collar received in the second aperture of the tubular body;
a paint roller comprising:
a spindle rod including a first end and a second end opposite to the first end;
a first reel rotatably mounted on the spindle rod proximate to the first end of the spindle rod, the first reel including an engagement portion at a first end thereof for releasably engaging the first collar; and
a second reel rotatably mounted on the spindle rod proximate to the second end of the spindle rod.

17. The paint roller assembly of claim 16, wherein the engagement portion of the first reel comprises a plurality of evenly spaced apart cantilever-type snap fittings arranged circumferentially therearound.

18. The paint roller assembly of claim 17, wherein the first collar comprises a tubular body defining a conical passage therethrough, and wherein the cantilever-type snap fittings engage one end of the tubular body of the first collar.

19. The paint roller assembly of claim 17, wherein the cantilever-type snap fittings comprise a projection which defines an angled assembly surface and an angled disassembly surface which allow the paint roller sleeve to be installed and removed.

20. The paint roller assembly of claim 16, wherein the first collar includes an engagement portion at a first end thereof, wherein the engagement portion of the first reel is one of an annular projection or an annular groove, and the engagement portion of the first collar
